(19) United States
(12) Patent Application Publication
(10) Pub. No.: US 2025/0186297 A1
(43) Pub. Date: Jun. 12, 2025

(54) Vibrating Massage Roller

(71) Applicant: Power Massage Products Inc, Fort Collins, CO (US)

(72) Inventor: Mark J. Rise, Fort Collins, CO (US)

(73) Assignee: Power Massage Products Inc, Fort Collins, CO (US)

(21) Appl. No.: 18/966,966

(22) Filed: Dec. 3, 2024

Related U.S. Application Data
(60) Provisional application No. 63/606,971, filed on Dec. 6, 2023.

(51) Int. Cl. A61H 15/00

(52) U.S. Cl. CPC A61H 15/0085; A61H 2015/0014; A61H 2015/0071; A61H 2201/0153; A61H 2201/0207; A61H 2201/0242; A61H 2201/1215; A61H 2201/14; A61H 2201/1671; A61H 2201/1685; A61H 2201/1695; A61H 2201/5097

(57) ABSTRACT

A handheld massager includes a carrier. The carrier supports and carries a massaging assembly and connects thereto. The messaging assembly includes a massaging portion and a support. The massaging portion resides about the support. The support fixedly connects to the carrier in fixed relation. The massaging portion is rotatable about the support. The support houses a powered force generating unit. The generating unit applies massaging forces to the massaging portion. In use, the massaging portion applies forces of pressure to a user's body as it rolls relative to the user's body, and the massaging portion further applies the massaging forces to the body.

This United States Non-Provisional Patent application claims the benefit of U.S. Provisional Patent Application No. 63/606,971, filed Dec. 6, 2023, hereby incorporated by reference herein.

### I. FIELD OF INVENTION

The present invention concerns an electrically powered handheld massager. More particularly the massager includes a massaging portion about a support. The massaging portion rolls by hand, pushing the massaging portion against and along a body portion and clothing on the body portion. The massaging portion rolls relative to the support, a powered force generating unit of the massager, and a carrier of the massager.

### II. BACKGROUND

US Patent Publication 2006/0116614 A1, Jun. 1, 2006, Jones et al., discloses a handheld massage assembly that is modular and allows a user the option of using a roller mechanized massager with or without a handle. In accordance with an embodiment of the present invention, the hand-held massage assembly includes a roller mechanized massager having an electro-mechanical connection. A handle is connectable to the electro-mechanical connection on the roller mechanized massager by a first electro-mechanical connection at one end thereof. The handle also has a second electro-mechanical connection at an opposite end. The first electro-mechanical connection and second electro-mechanical connection of the handle are electrically coupled to each other. A power cord having an electro-mechanical connection is coupled to the second electro-mechanical connection on the handle. All of the electro-mechanical connections are designed such that the handle may be removed from the assembly and the electro-mechanical connection of the power cord may be coupled directed to the electro-mechanical connection of the roller mechanized massager.

U.S. Pat. No. 5,215,078, Fulop, Jun. 1, 1993, discloses a massager which includes an electric motor driven eccentric cam in a housing. A moving member is slidably mounted on the housing and is driven by the eccentric cam in a reciprocating, translatory motion. A hand grip is mounted on each of the opposed ends of the moving member. The massager is held in the two hands by the hand grips. A housing reciprocates in translatory motion relative to the hand grips and imparts inertial forces to the grips and the hands for massaging action on both the hands and arms simultaneously. The massager is more easily held by arthritic hands than conventional devices. The device may be held between other paired body parts such as ankles and knees for applying massage therapy thereto. An alternative embodiment includes a series of parallel rollers pivotally attached to the housing for application to a body part such as the scalp when held by the two hand grips.

### III. SUMMARY

A handheld massager having a particular construction embodies the objects and advantages of the present invention. An exemplary massager embodying some of the objects and advantages of the present invention is described herein. The exemplary massager includes a support fixedly connects to a carrier in a fixed relation. A powered force generating unit which creates massaging forces, when the massager is turned on, connects to the support. A massaging portion resides about the support and is rotatable about the support and is rotatable relative to the carrier. The massaging forces created by the powered force generating unit are applied to the massaging portion. In use, the massaging portion applies forces of pressure to a user's body as it rolls relative to the user's body, and the massaging portion further applies the massaging forces to the body.

In more detail the powered force generating unit includes a prime mover. The powered force generating unit also includes a first drive shaft extending from a first end of the prime mover. A second drive shaft extending from a second end of the prime mover. The prime mover is an electric motor. A first eccentric fixedly connects to the first drive shaft. A second eccentric fixedly connects to the second drive shaft. When the massager is turned on, the prime mover rotates the drive shafts; the rotation of said drive shafts rotates the eccentrics. The prime mover is connected to the support with a press fit. The support is fixedly connected to the carrier in fixed relation. The motor can include a stator and rotor. The handheld massaging portion can be formed with a resilient and easily hand compressible material. The resilient and easily hand compressible material is rubber and/or silicone. A portion of the massaging portion can delimit a void space that is fillable with warm water. Alternatively or in addition, the massaging portion can comprise beads in the void space. In some embodiments, at least a portion of the support is disconnectable and reconnectable by a user, by hand, to and from the carrier. In this embodiment, the massaging portion is interchangeable, when at least a portion of the support is disconnected from the carrier, with another massaging portion selectable from a group of massaging portions. In another embodiment the massaging portion is fixedly coupled to the support in fixed relation and the support is rotatably connected to the carrier.

The invention also includes an exemplary method of making a massager. The method includes installing a power supply in a housing of a carrier. A support is fixedly connected, in fixed relation, to the carrier. A powered force generating unit is installed in a void space delimited by the support. A massaging portion is disposed about the support. The disposal rotatably couples the massaging portion to the support portion enabling the massaging portion to roll relative to the support.

### IV. BRIEF DESCRIPTION OF THE DRAWINGS

FIG. 1 discloses an isometric view of a handheld electric power massager embodying features of the present invention.

FIG. 2 is a top view of the massager shown in FIG. 1.

FIG. 3 is a partially exploded view of the massager showing the massaging portion exploded from a support of the massager.

FIG. 4 is a front view of the massager shown in FIG. 1.

FIG. 5 is a rear view of the massager shown in FIG. 1.

FIG. 6 is a left sided view of the massager with the massaging portion exploded off the support.

FIG. 7 is a sectional view of the massager shown in FIG. 5 taken along view lines 7-7.

Before any embodiments of the invention are explained in detail, it is to be understood that the invention is not limited in its application to the details of construction and arrangement of components set forth in the present description or as illustrated in the drawings. The invention is capable of other embodiments and of being practiced or of being carried out in various ways. Also, it is to be understood that the phraseology and terminology used herein is for description and should not be regarded as limiting. The use of “including,” “comprising” or “having” and variations thereof herein is meant to encompass the items listed thereafter and equivalents thereof as well as additional items. Unless specified or limited otherwise, the terms “mounted,” “connected,” “supported,” and “coupled”, “abutted”, “imparted” “against”, and variations thereof are used broadly and encompass both direct and indirect mountings, connections, supports, couplings, abutments and impartments. The phrases: “in”, “resides in”, “resides” “between”, “over”, “closed”, “forms”, “delimit(s)” and “covers” does not mean completely “in”, “resides in”, “resides”, forms “between” “over”, “closed”, “delimit(s)” and “covers”. The phrases encompass partially “in”, “resides in”, “resides”, “forms”, “between”, “over”, “delimit(s)” and “covers”. Further, “connected” and “coupled” and “abut” are not restricted to physical or mechanical connections or couplings.

### V. DETAILED DESCRIPTION

The drawings referred to and the present detailed description provide only examples of constructions of a massager that incorporate the features of the present invention. Other constructions can incorporate the features of the invention.

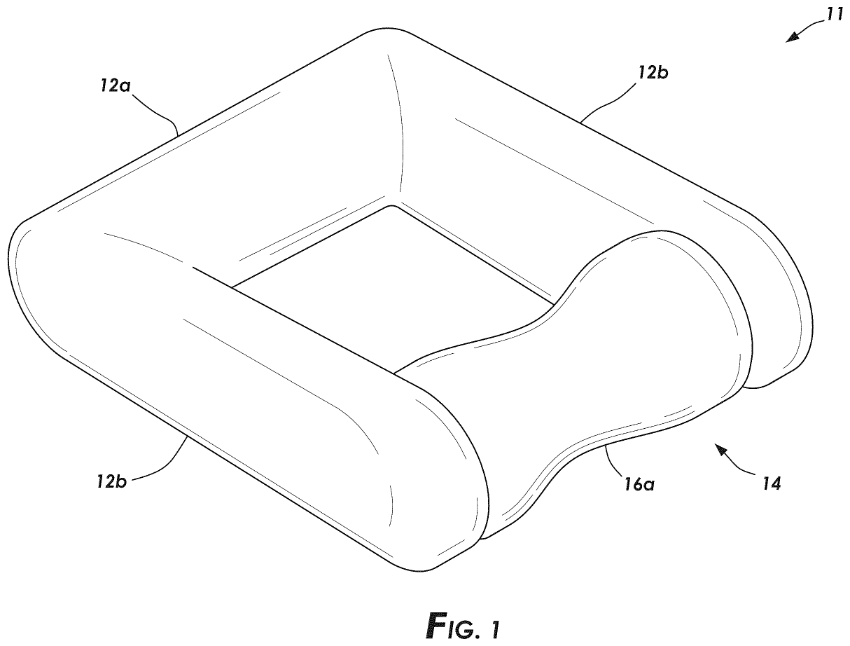

As shown in FIG. 1 a handheld massager (11) includes a carrier (12a, 12b). The carrier supports and carries a massaging assembly (14) and connects thereto. As shown in FIG. 7, the messaging assembly (14) includes an applicator. The applicator (16a, 16b) includes a massaging portion (16a) and a support (16b). The massaging portion (16a) resides about the support (16b). Support (16b) is fixedly connected to carrier (12a, 12b) in fixed relation. The massaging portion (16a) is rotatable about the support (16b). A prime mover (18a) of a powered force generating unit connects to a movement (18b) of the force generating unit. Support (16b) fixedly connects to the prime mover (18a). Massaging assembly (14) includes the applicator (16a, 16b) and force generating unit (18a, 18b, 18c).

In operation, a user of the handheld massager (11) powers on the massager (11) by pressing the actuator (20) shown in FIG. 5. A power supply (22) carried by a power supply housing (12a) formed as part of the carrier (12a, 12b), provides power to the prime mover (18a). The prime mover (18a) provides an emotive force to the movement (18b). The emotive force moves movement (18b). The movement (18b) creates forces which eventually are applied and distributed to the massaging portion (16a) of the applicator (16a, 16b). The forces applied and distributed to the massaging portion (16a) provide the massaging portion (16a) of the applicator (16a, 16b) with a massaging force which can be felt by the user as vibrations.

To feel the soothing effects of the massaging force, such as vibrations, the user, while holding the carrier (12a, 12b), brings the applicator (16a, 16b) towards its body to cause the applicator (16a, 16b), through the massaging portion (16a), to apply force, such as pressure, to the body. The user feels both the pressure force and the vibrations. Both types of forces impart sensations to the user which feel soothing.

The massager (11) allows the user to apply deep pressure forces over the body by firmly pressing the applicator (16a, 16b) against the user and moving the applicator (16a, 16b) along the user's arms, legs, torso, neck, etc. During movement along the body, the massage portion (16a) rolls relative to the user, the carrier (12a, 12b) and the support (16b). The ability of the massaging portion (16a) to roll relative to the body facilitates the distribution over the body, by the user, of the pressure forces caused by the massaging portion (16a) of the applicator (16a, 16b). In addition to the pressure forces generated by the user pushing the massaging portion (16a) of the applicator (16a, 16b) firmly against the body, the user also feels the soothing force of the vibrations caused by the powered force generating unit (18a, 18b, 18c). The applicator (16a, 16b), by employing massaging portion (16a), which roles relative to the body under manual force, facilitates the distribution of these forces as the user roles the massaging portion (16a) of applicator (16a 16b) along the user's body.

In more detail, with reference to FIG. 7, the support (16b) delimits a void space in which resides the powered force generating unit (18a, 18b, 18c). The support (16b) includes an interior (16b′) and exterior surface (16b″) and delimits the void space. A press fit with the interior surface (16b′) fixes the prime mover 18a in place relative to the support (16b). The support (16b), in the present case, forms and is a housing (16b) for the powered force generating unit (18a, 18b, 18c). The housing (16b) forms the void space in which resides the powered force generating unit (18a, 18b, 18c). The housing (16b) further forms the interior (16b′) and exterior surface (16b″). The prime mover (18a) press fits to the housing interior surface (16b′).

Now referring to the massaging portion (16a) of the applicator (16a, 16b) in more detail, with refence to FIG. 7, the portion comprises, in the present example, a resilient, elastomeric, easily hand compressible material. The material may comprise rubber, silicone, etc. The massaging portion (16a), which can be called a rolling portion (16a), can have various constructions to improve the soothing sensation it causes on the user by the user pressing the rolling portion (16a) against the user. For instance, the rolling portion (16a) can define a void space filled with gel and/or nodules such as plastic beads. The nodules can be suspended in the gel, which move relative to an exterior surface (16a′) of the rolling portion. The massaging portion (16a) may be fillable with warm water. The massaging portion exterior (16a′) surface can comprise a recessed area between raised surfaces. The exterior surface (16a′) can comprise protruding surfaces such as knobs of various sizes, knobs of uniform sizes, ridges, and combinations thereof. The exterior surface (16a′) can also comprise recessed surfaces such as grooves. The massaging portion (16a) extends about the support (16b). The portion (16a) includes an interior surface (16a″) and opposite facing exterior surface (16a′). The interior surface (16a″) resides proximate the support (16b), and the exterior surface (16a′) resides distal to the support (16b) relative to the interior surface (16a″). The massaging portion (16a) and its interior surface (16a″) reside about the support (16b) and encircles the support (16b) for 360 degrees. The massaging portion (16a) can rotate, under applied force, continuously about the support (16b) in either a first rolling direction (24a) or a second rolling direction (24b) opposite the first direction (24a).

To facilitate rotation of the massaging portion (16a) about the support (16b), a variety of constructions (26) can be used. For instance, one can use a bearing such as a sleeve bearing. For example, one could use a sleeve bearing with a highly slick interior PTFE surface about the support (16b) and the massaging portion (16a) about the sleeve bearing. One could also use a roller or ball bearing as opposed to a sleeve bearing. As opposed to a bearing, one can form the interior massaging portion surface (16a″) to comprise slick material (26). One could also dispose a lubricant between the massaging portion (16a) and support (16b).

As opposed to one massaging portion (16a) extending along the length of the support (16b) in the axial direction, the massager (11) can employ a plurality of individual massaging portions along the support (16b). Each portion can continuously rotate, under applied force, about the support in either the first (24a) or second rolling directions (24b). Alternatively, the applicator (16a, 16b) can comprise a carrying support portion about which rolling massaging portion(s) (16a) reside. The rolling massaging portion(s) (16a) can rotate continuously, under applied force, about the carrying support in either the first (24a) or second (24b) rolling directions. The carrying support can connect the rolling massaging portion(s) (16a) to the support (16b). The connection fixes the carrying support in place relative to the support (16b).

In a further embodiment, the massager (11) can comprise a construction that allows a user to interchange massaging portion(s) (16a) with one another to enable a user to change the massaging sensation provided by the massaging portion(s) (16a). To facilitate interchangeability, the support (16b) removably connects in fixed relation to the carrier (12a, 12b). When in a disconnected state a user can exchange one type of massaging portion (16a) or portions for another or others. In the disconnected state a user can also remove a massaging portion (16a) carrying beads or water. The user can then heat the massaging portion (16a) and reinstall it on the support (16b). Preferably the massaging portion (16a), carrying beads for heating, comprises a textile covering to house the beads. Once the user installs the desired massaging portion (16a), the user then reconnects the support (16b) to the carrier (12a, 12b). In an alternative construction, rather than having to disconnect and reconnect the support (16b) to the carrier (12a, 12b), each massaging portion (16a) can employ a clamshell construction. The construction allows for disconnection and reconnection of the massaging portions about the support while the support resides fixedly connected to the carrier.

In a still further different construction of the applicator (16a, 16b), the support (16b) connects to the massaging portion (16a) in fixed relation. The massaging portion (16a) does not rotate relative to the support (16b). The support (16b) rather rotates relative to the carrier (12a, 12b). Under the fixed relation construction, the support portion (16b) of the applicator (16a, 16b) carries the power supply (22). The actuator (20) operates the power supply (22) under a wireless connection. The support (16b) could include spindles on opposite sides of the support (16b) which rotatably connect to the carrier (12a, 12b). Lugs or pins can be used in place of spindles.

The applicator (16a, 16b), as described above, can be called a roller.

The powered force generating unit (18a, 18b, 18c), as shown in FIG. 7, includes two drive shafts (18c) extending from opposite sides of the prime mover (18a). One eccentric cam (18b) is connected to one of the two drive shafts (18c). Another eccentric cam (18b) is connected to the other of the two drive shafts (18c). The eccentrics (18b) translate the rotational movement of the shafts (18c) into up and down forces imparted on the prime mover (18a). The forces are felt as vibrations in the massaging portion (16a). In the present case, the prime mover (18a) comprises an electric motor hard wired to the power supply (22) which is a rechargeable battery. Alternatively, the prime mover (18a) can move percussors which are felt as percussions in the massaging portion (16a). As a further alternative, prime mover (18a) can move kneaders which are felt as a kneading sensation in the messaging portion (16a). The support (16b) can contain a combination of vibrators, percussors and kneaders.

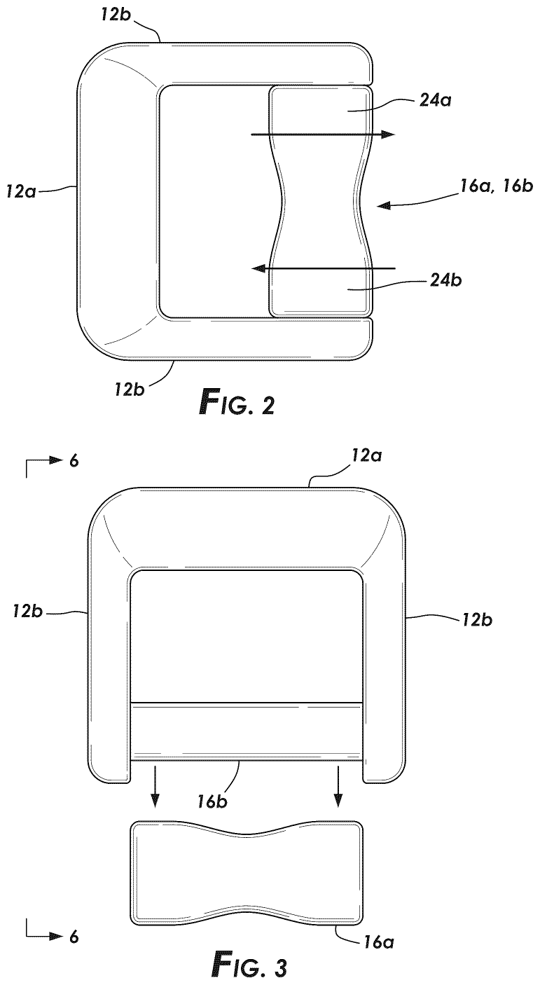

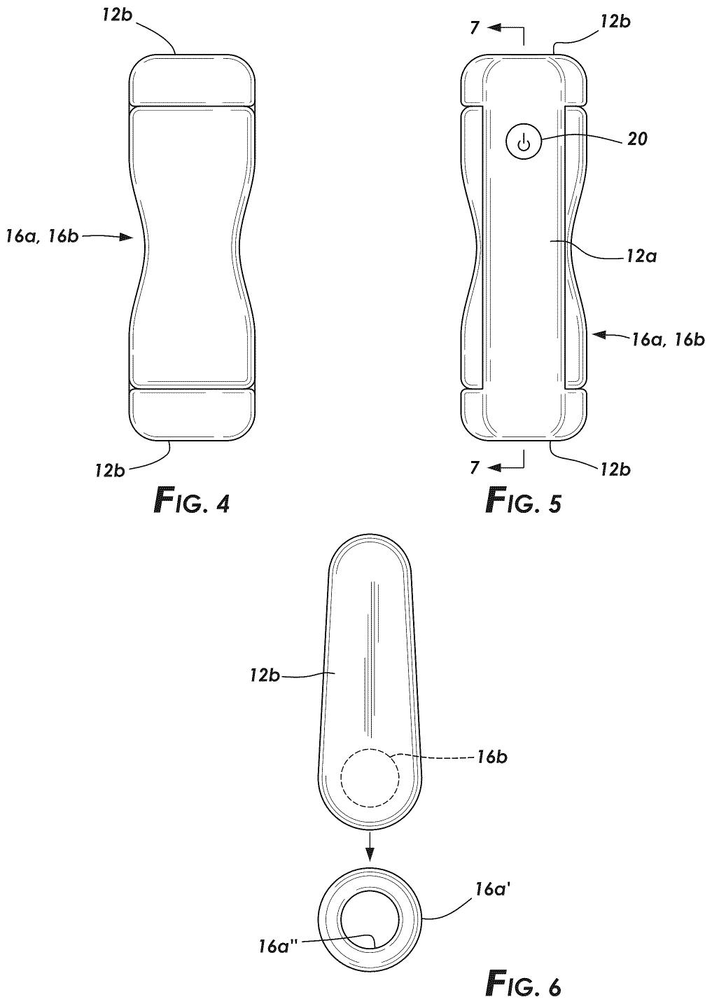

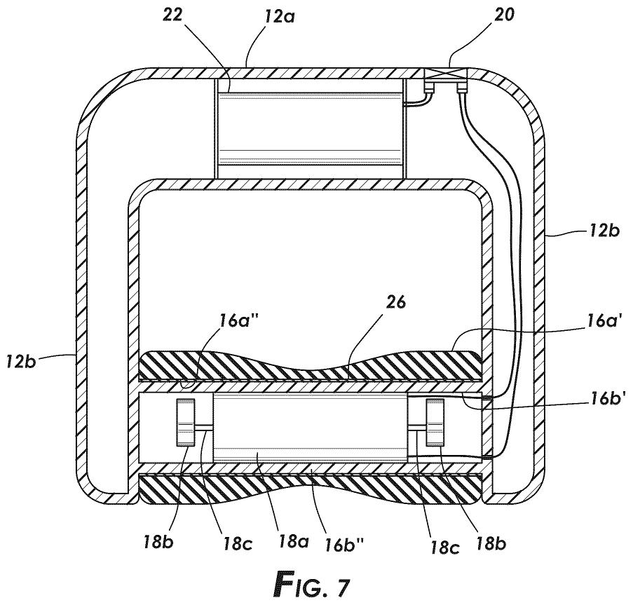

The carrier (12a, 12b) as shown in FIGS. 1-7 includes arms (12b). The applicator (16a, 16b) resides between the arms (12b). One side portion of the applicator (16a, 16b), along its axis, is connected to one arm end portion of one arm (12b). Another side portion of the applicator (16a, 16b), along its axis, is connected to the other arm (12b) at an end portion of the arm. Each arm (12b) has an end portion opposite its portion which connects the arm to the applicator (16a, 16b). Each opposite arm end portion connects its arm (12b) to the power supply housing (12a).

As can be easily understood from the foregoing, the basic concepts of the present invention may be embodied in a variety of ways. The invention involves numerous and varied embodiments and methods for making and using such embodiments. As such, the particular embodiments or elements of the invention disclosed by the description or shown in the figures accompanying this application, are not intended to be limiting but rather exemplary of the numerous and varied embodiments generically encompassed by the invention or equivalents encompassed with respect to any particular element thereof. In addition, the specific description of embodiment(s) or element(s) of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “support” should be understood to encompass the disclosure of the act of “supporting”—whether explicitly discussed or not—and, conversely, were there is effectively the disclosure of the act of “disposing” such a disclosure should be understood to encompass the disclosure of the apparatus of performing the act, such as “a disposer”, and even a means for accomplishing the act, such as “means for disposing”. Such alternatives for each element or step are to be understood to be explicitly included in the description.

In addition, as to each term used, it should be understood that unless its utilization in this application is inconsistent with such interpretation, common dictionary definitions should be understood to be included in the description for each term.

The background section of this patent application includes or contains reference to United States Patents and/or Publications. It is not intended that any United States Patent or Publication be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A handheld massager comprising:
a carrier;
a support connected to the carrier;
a powered force generating unit which creates forces when the massager is turned on, said powered force generating unit connected to said support;
a massaging portion connected to said carrier and rotatable relative thereto; and wherein,
said forces created by said powered force generating unit are applied to said massaging portion.

2. The handheld massager of claim 1, wherein said powered force generating unit comprising:
a prime mover.

3. The handheld massager of claim 2, wherein said powered force generating unit comprising:
a first drive shaft extending from a first end of said prime mover;
a second drive shaft extending from a second end of said prime mover;
a first eccentric fixedly connected to said first drive shaft;
a second eccentric fixedly connected to said second drive shaft; wherein,
said prime mover is an electric motor; and
when said massager is turned on, said prime mover rotates said drive shafts, said rotation of said drive shafts rotates said eccentrics.

4. The handheld massager of claim 3, wherein,
said prime mover is connected to said support with a press fit.

5. The handheld massager of claim 4, wherein,
said massaging portion resides about said support, said massaging portion rotatable about said support; and
said support fixedly connected to said carrier in fixed relation.

6. The handheld massager of claim 5, wherein,
said motor includes a stator and rotor.

7. The handheld massager of claim 1, wherein,
said massaging portion resides about said support.

8. The handheld massager of claim 7, wherein,
said massaging portion is formed with a resilient and easily hand compressible material.

9. The handheld massager of claim 8, wherein,
the resilient and easily hand compressible material is rubber and/or silicone.

10. The handheld massager of claim 7, wherein,
a portion of said massaging portion delimits a void space.

11. The handheld massager of claim 10, wherein,
the void space is fillable with warm water.

12. The handheld massager of claim 10, wherein the massaging portion comprises:
beads in said void space.

13. The handheld massager of claim 7, wherein the massaging portion comprises:
an exterior surface.

14. The handheld massager of claim 13, wherein the exterior surface of the massaging portion comprises:
a recessed surface portion between raised surface portions.

15. The handheld massager of claim 13, wherein the exterior surface of the massaging portion comprises:
protruding surfaces.

16. The handheld massager of claim 15, wherein the protruding surfaces form a shape selected from a group the shapes consisting of knobs, nodules, and ridges and combinations thereof.

17. The handheld massager of claim 7, wherein,
at least a portion of the support is disconnectable and reconnectable by a user, by hand, to and from said carrier; and wherein,
the massaging portion is interchangeable, when at least a portion of the support is disconnected from the carrier, with another massaging portion selectable from a group of massaging portions.

18. The handheld massager of claim 7, wherein,
the massaging portion is fixedly coupled to said support in fixed relation and said support is rotatably connected to said carrier.

19. A method of making a massager, comprising:
providing a carrier having a power supply housing;
installing a power supply in the housing of the carrier;
fixedly connecting a support, in fixed relation, to the carrier;
installing a powered force generating unit in a void space delimited by the support;
disposing a massaging portion about the support; and wherein,
said disposal, rotatably couples said massaging portion to said support portion enabling said massager portion to roll relative to said massaging portion.

20. The method of making the massager of claim 19 wherein installing a powered force generating unit in a void space delimited by the support, further comprises:
installing in the void space installing an electric motor having a first drive shaft extending from a first end of said electric motor and a second drive shaft extending from a second end of said prime mover;
fixedly connecting a first eccentric to said first drive shaft and fixedly connecting a second eccentric to said second drive shaft; and wherein,
when said massager is turned on, said prime mover rotates said drive shafts, said rotation of said drive shafts rotates said eccentrics.
